(19) United States
(12) Patent Application Publication
(10) Pub. No.: US 2004/0030580 A1
(43) Pub. Date: Feb. 12, 2004

(54) Apparatus for dispensing electrotherapy treatment programs

(76) Inventor: Ryan Byleveld, Boksburg (ZA)

Correspondence Address: NIXON & VANDERHYE, PC, 1100 N GLEBE ROAD, 8TH FLOOR, ARLINGTON, VA, 22201-4714, US

(21) Appl. No.: 10/415,071

(22) PCT Filed: Oct. 25, 2001
(86) PCT No.: PCT/ZA01/00163

(30) Foreign Application Priority Data
Oct. 25, 2000 (ZA) 2000/5983

(51) Int. Cl. G06F 17/60

(52) U.S. Cl. 705/2

(57) ABSTRACT

A system (10) for making available electrotherapy programs comprises a central dispensing computer (12) hosting a database (14). The database comprises program data relating to each of a plurality of electrotherapy programs. the system further comprises communications means (18) for transmitting the program data to a remote destination station (16), such as a doctor's consulting room or a pharmacy. At the destination station an electrotherapy apparatus (28) is selectively brought into data communication relationship with the communications means, to receive data relating to selected or prescribed programs. The programs are then executed by the apparatus to apply signals to a body of a patient, to treat the patient.

### TECHNICAL FIELD

THIS invention relates to a system and apparatus for use in electrotherapy, a method of dispensing treatment programs and a method of treating a patient.

### DISCLOSURE OF THE INVENTION

According to the invention there is provided a system for making electrotherapy programs available, the system comprising:

a central computer hosting a database;

the database comprising program data relating to each of a plurality of electrotherapy programs;

communications means for transmitting the program data to a remote destination station; and

at least one electrotherapy apparatus which is brought into data communication relationship with the communications means at the destination station, to receive the data.

The communications means may comprise a dedicated link, either physical or wireless, between the central computer and the destination station.

The destination station may comprise a local server and a local network of computers connected to the local server. The server and local network may be located at a consulting room of an intermediary, such as a doctor or pharmacist.

In other embodiments, the communications means may comprise a publicly accessible data network, such as the internet, a cellular or mobile phone network etc. More particularly, the network may comprise a cellular phone network and the destination station a cellular phone connectable to the network. The apparatus may be brought into data communication relationship with the cellular phone via an infrared link, for example.

In yet further embodiments the apparatus may be incorporated in a housing of the cellular phone.

The program data may be downloaded and stored in the apparatus in the form of suite data relating to a suite of selected programs. The suite data may comprise data relating to at least one parameter of a signal to be generated during execution of a respective selected program. The at least one parameter is pr ferably a frequency of the signal.

Each program may comprise a plurality of consecutive phases, each phase being associated with a respective signal having a respective frequency and the suite data may comprise frequency data relating to each respective frequency.

The at least one electrotherapy apparatus may comprise an electronic controller and a signal generator, the controller being operative to cause the signal generator to generate the signal during execution of the program.

The suite data may further comprise count data relating to a count for each selected program in the suite and the apparatus may comprise a counter, the controller and counter being operative to limit a number of executions of a program in the suite to the count for the program.

Further included within the scope of the invention is a portable apparatus for executing electrotherapy programs, the apparatus comprising:—

an electronic controller;

data receiving means for receiving from an external source data relating to a suite of selected treatment programs for a treatment cycle, th suite data comprising data relating to a respective count for each program in the treatment cycle;

memory means for storing the suite data;

a counter cooperating with the controller;

a signal generator for utilizing the suite data to generate respective signals in accordance with the programs; and

the counter and controller being operative to limit a number of times a program is executed in a cycle to the respective count for that program.

Yet further included within the scope of the invention is a method of dispensing electrotherapy programs, the method comprising the steps of:

storing program data relating to a plurality of electrotherapy programs in a database;

enabling a selection of the program data to be made; and

at a remote site, causing the selected program data to be downloaded into an electronic electrotherapy apparatus.

In one form of the method a patient is caused to make the selection and to pay for the programs in advance, before the data is downloaded.

In another form of the method the program data may be downloaded to distributed dispensing stations, an intermediary at one of said dispensing stations may be caused to make a selection of data relating to a suite of selected and prescribed programs for a treatment cycle for a patient, the suite data may then be downloaded into a treatment apparatus; and the patient may then cause the apparatus to execute the programs.

Still further included within the scope of the invention is a method of treating a patient, the method comprising the steps of:—

prescribing a suite of electrotherapy programs for the patient;

causing data relating to the suite to be downloaded into an electronic electrotherapy apparatus capable of executing the data and the programs; and

causing the programs to be executed by the apparatus and signals generated in accordance with the programs to be applied to the patient, to treat the patient.

### BRIEF DESCRIPTION OF THE ACCOMPANYING DIAGRAMS

The invention will now further be described, by way of example only, with reference to the accompanying diagrams wherein:

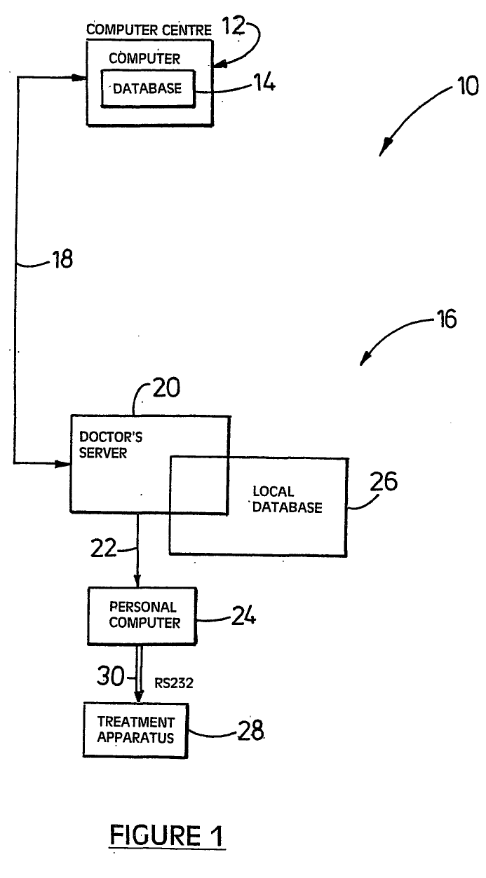

FIG. 1 is a block diagram of a first embodiment of the system according to the invention;

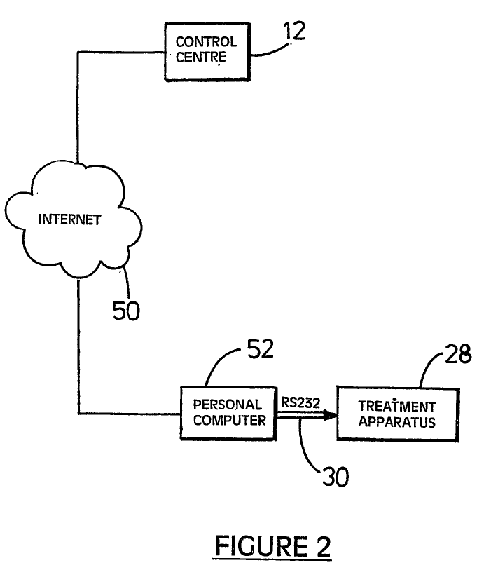

FIG. 2 is a block diagram of a s cond embodiment of the system according to the invention;

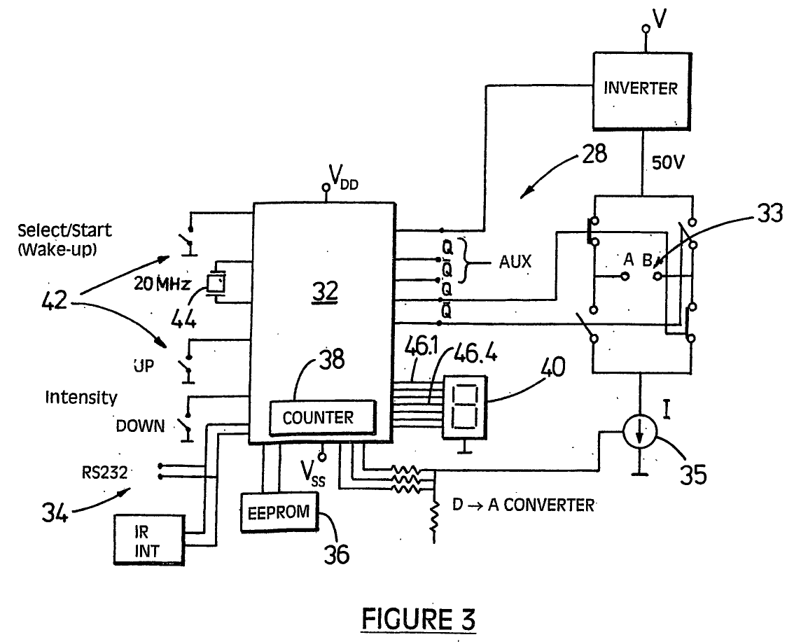

FIG. 3 is a block diagram of a control circuit for a treatment apparatus according to the invention;

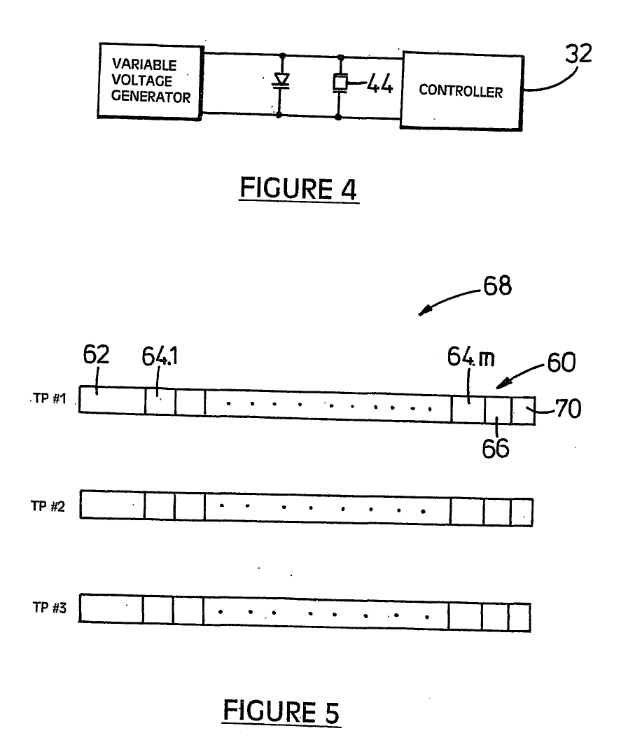

FIG. 4 is a basic diagram of a frequency control circuit forming part of the control circuit;

FIG. 5 is a diagrammatic representation of suite data to be downloaded into the treatment apparatus; and

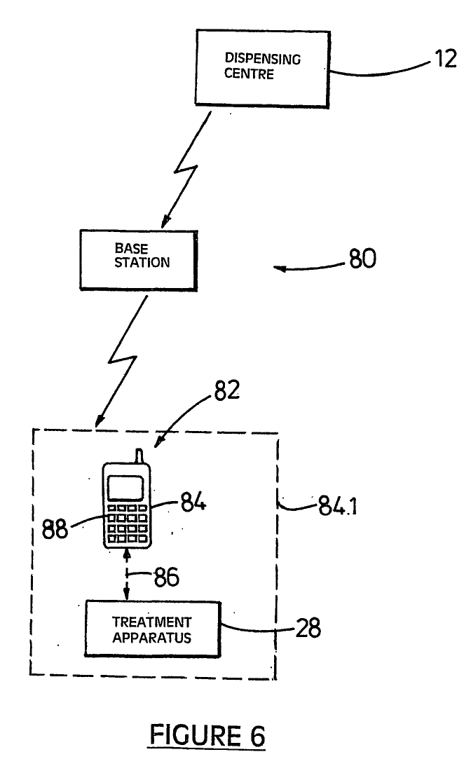

FIG. 6 is a block diagram of a third embodiment of the system according to the invention.

### DESCRIPTION OF PREFERRED EMBODIMENTS OF THE INVENTION

A system according to the invention for making available and dispensing programs for use in electrotherapy is generally designated by the reference numeral 10 in FIG. 1.

The system 10 comprises a central control and dispensing centre 12 comprising a computerized database 14. At the center 12, respective electrotherapy programs for a variety of medical conditions are developed and/or procured and digital data relating to these programs is stored in the database. The program data is continually improved on and updated. New program data, once available, is also added to the database. As will be explained in more detail hereinafter, each program comprises data relating to an electronic signal to be generated by an electrotherapy apparatus 28 for use in electrotherapy, to treat a particular condition. These programs are also referred to as electro-medicine or vibrational medicine.

In a first embodiment shown in FIG. 1, the program data in the database is made available to a plurality of distributed stations 16 such as respective computer systems at respective consulting rooms of doctors, pharmacists or the like. The data may be so made available and downloaded in encrypted form via a dedicated communications link 18, whether physical (for example wired or optical fiber) or wireless.

The station 16 may typically comprise a server 20 connected or connectable via a local area network (LAN) 22 to a plurality of personal computers 24.

The server 20 hosts a local database 26 for storing program data relating to the available treatment programs received and downloaded from the database 14.

A portable el ctronic electrotherapy apparatus 28 is connectabl to the network 22 via personal computer 24 and an RS 232 link 30. The apparatus, which is shown in more detail in FIG. 3, is of the kind whereby a signal associated with a treatment program and generated in accordance with respective program data is applied to the body (not shown) of a patient (also not shown) via one or more electrodes 33. The signal is preferably provided by a voltage controlled current drain 35 of the apparatus.

There may be p treatment programs TP#1 to TP#p available in the database 14, each comprising one to m phases. For example:

TP#1 is for the treatment of abdominal pain, comprises four consecutive phases each having a unique frequency f₁ to f₄ for a signal to be generated and to be applied to the body of the patient via the aforementioned electrodes. For TP#1: f₁=10 KHz; f₂=3 Hz; f₃=3 KHz and f₄=95 HZ.

TP#2 is for the treatment of abscesses, comprises six consecutive phases each having a unique frequency f₁ to f₆ for a signal to be generated and to be applied to the body of the patient wherein f₁=2720 Hz; f₂=2170 Hz; f₃=880 Hz; f₄=787 HZ; f₅=190 Hz and f₆=500 Hz.

TP#3 is for the treatment of acne, comprises thirteen consecutive phases each having a unique frequency wherein f₁=2720 Hz; f₂=2170 Hz; f₃=1800 Hz; f₄=1600 HZ; f₅=1550 Hz; f₆=1552 Hz; f₇=1500 Hz; f₈=802 Hz; f₉=880 HZ; f₁₀=787 Hz; f₁₁=727 Hz; f₁₂=564 Hz; and f₁₃=778 Hz.

TP#4 is for the treatment of Anthrax, comprises six consecutive phases each having a unique frequency f₁ to f₈ for a signal to be generated and to be applied to the body of the patent wherein f₁=500 Hz; f₂=633 Hz; f₃=1365 Hz; f₄=1370 HZ; f₅=768 Hz; and f₆=414 Hz.

TP#p is for the treatment of alcoholism and comprises a single phase wherein the frequency of the signal to be applied as hereinbefore described is 10 kHz.

The program data for a program is diagrammatically shown in FIG. 5. For example, the program data relating to TP#1 comprises a header 62, a train of m consecutiv fi Ids 64.1 to 64.m each comprising encrypted data relating to the aforementioned frequenci s. Thus, in field 64.1 there will be encrypted data specifying a frequency f₁ of 10 KHz. Since there are only four phases in TP#1, fields 64.5 to 64.m will each comprise data designating a zero frequency. In field 66 there is stored data relating to the time duration of each phase. In this example, the time duration for each and all phases is in the order of 3 minutes.

As shown in FIG. 3, the apparatus 28 comprises a controller 32, an RS 232 and infrared interface 34 for receiving suite data comprising data relating to selected or prescribed programs as will hereinafter be described, a memory arrangement 36 for storing the suite data and a counter 38. The apparatus further comprises a display 40 and user/patient manipulatable keys, switches or knobs 42 for in use providing the controller 32 with user instructions.

The suite data 68 shown in FIG. 5 is based on a prescription by an intermediary such as a doctor or pharmacist at the destination station 16 of TP#1 to TP#3 of the available treatment programs (TP#1 to TP#p) for a treatment cycle. The data comprises data for each selected program including parameter data 64.1 to 64.m relating to each phase in the program and count data 70 relating to a count for each program in the treatment cycle. The parameter data includes data relating to parameters of a waveform of a signal to b generated and such data may includ the frequency of the signal as hereinbefore described; a total time duration of each phase; a duty cycle of the signal and any other data such as rise time etc.

The suite data 68 is dispensed into the apparatus 28 and stored in memory arrangement 32. The patient pays the doctor or pharmacist for the programs received. At the end of an accounting period the doctor pays a service provider making the programs available from database 14 for all programs dispensed by him during the period.

The apparatus 28 is then used by the patient to execute the treatment programs as prescribed in accordance with a printed guide or prescription, which includes data relating to when each program must be executed and where on the body the respective signal must be applied. The counter 38 ensures that each program is executed during the cycle a number of times not exceeding the count 70 prescribed and paid for. Should the patient require further treatment, further suite data 68 for a further treatment cycle is prescribed, paid for and dispensed as hereinbefore described.

In FIG. 4 there is shown a circuit 42 which in operation causes the aforementioned frequency of the signal of each phase during that phase to be swept through a range from −10% of the aforementioned frequency of the signal to +10% of the frequency, by linearly varying a voltage applied to crystal 44 shown in FIG. 3, in saw-tooth fashion.

It is envisaged that the patient need not own the treatment apparatus 28, but that it may be made available on loan, rent or the like to him by the doctor or the service provider.

In the embodiment shown in FIG. 2, the patient may himself make the selection of treatment programs (probably at the hand of a publicly available guide made available by the service provider, for example on a suitable website) and download the suite data via the internet 50 and his personal computer 52 into the apparatus 28. The patient pays for the selected programs utilizing any suitable payment method, including electronic methods.

Thereafter signals in accordance to the programs selected and paid for are applied by the apparatus 28 as hereinbefore described. Should the patient require treatment beyond the programs paid for, the procedure is repeated.

In FIG. 6 there is shown a further embodiment of the system and of the apparatus. Encrypted suite data is transmitted or dispensed on request of a user via a cellular or mobile phone system 80 from central database 12 to a memory arrangement of a mobile phone 82 of the user. The data is then under control of the user downloaded via an infrared link 86 into a memory arrangement 36 of the treatment apparatus 28. In the treatment apparatus the data is decrypted, the signals are generated and applied via electrodes 33 to the body of the user in the manner hereinbefore described.

In other embodiments the treatment apparatus 28 may be included or incorporated in the conventional housing 84.1 of a mobile phone as indicated by broken lines in FIG. 6. In such a case the external link 86 is not required and the signals are applied to the body of the user via conventional electrodes 33 connectable to contacts on the mobile phone housing. The apparatus is controlled by the user utilizing the keypad 88 of the mobile phone to input commands to the apparatus 28.

1. A system for making available electrotherapy programs, the system comprising:—
a central computer hosting a database;
the database comprising program data relating to each of a plurality of electrotherapy programs;
communications means for transmitting the program data to a remote destination station; and
at least one electrotherapy apparatus which is brought into data communication relationship with the communications means at the destination station, to receive the data.

2. A system as claimed in claim 1 wherein the communications means comprises a dedicated link between the central computer and the destination station.

3. A system as claimed in claim 1 wherein the communications means comprises a public data network.

4. A system as claimed in any one of claims 1 to 3 wherein the destination station comprises a computer and wherein the apparatus is connectable to the computer.

5. A system as claimed in claim 3 wherein the network comprises a cellular phone network and the destination station a cellular phone connectable to the network and wherein the apparatus is brought into data communication relationship with the cellular phone.

6. A system as claimed in claim 5 wherein the apparatus is incorporated in a housing of the cellular phone.

7. A system as claimed in any one of the preceding claims wherein the program data is downloaded and stored in the apparatus in the form of suite data relating to a suite of selected programs.

8. A system as claimed in claim 7 wherein the suite data comprises data relating to at least one parameter of a signal to be generated during execution of a respective selected program.

9. A system as claimed in claim 8 wherein the at least one parameter is a frequency of the signal.

10. A system as claimed in claim 9 wherein each program comprises a plurality of consecutiv phases, each phase being associated with a respectiv signal having a respective fr quency and wherein th suite data comprises frequency data relating to each respective frequency.

11. A system as claimed in any one of claims 7 to 10 wherein the at least one electrotherapy apparatus comprises an electronic controller and a signal generator, the controller being operative to cause the signal generator to generate the signal during execution of the program.

12. A system as claimed in claim 11 wherein the suite data further comprises count data relating to a count for each selected program in the suite and the apparatus comprises a counter, the controller and counter being operative to limit a number of executions of a program in the suite to the count for the program.

13. A portable apparatus for executing electrotherapy programs, the apparatus comprising:—
an electronic controller;
data receiving means for receiving from an external source data relating to a suite of selected treatment programs for a treatment cycle, the suite data comprising data relating to a respective count for ach program in the treatment cycle;
memory means for storing the suite data;
a counter cooperating with the controller; and
a signal generator for utilizing the suite data to generate respective signals in accordance with the programs; and
the counter and controller being operative to limit a number of times a program is executed in a cycle to the respective count for that program.

14. A method of dispensing electrotherapy programs, the method comprising the steps of:
storing program data relating to a plurality of electrotherapy programs in a database;
enabling a selection of the program data to be made; and
at a remote site, causing the selected program data to be downloaded into an electronic electrotherapy apparatus.

15. A method as claimed in claim 14 wherein a patient is caused to make the selection and to pay for the programs in advance, before the data is downloaded.

16. A method as claimed in claim 14 wherein the program data is downloaded to distributed dispensing stations, wherein an intermediary at one of said dispensing stations is caused to make a selection of data relating to a suite of selected and prescribed programs for a treatment cycle for a patient, wherein the suite data is then downloaded into a treatment apparatus; and wherein the patient causes the apparatus to execute the programs.

17. A method of treating a patient, the method comprising the steps of:—
prescribing a suite of electrotherapy programs for the patient;
causing data relating to the suite to be downloaded into an electronic electrotherapy apparatus capable of executing the data and the programs; and
causing the programs to be executed by the apparatus and signals generated in accordance with the programs to be applied to the patient, to treat the patient.
